(19) United States
(12) Patent Application Publication
(10) Pub. No.: US 2011/0300804 A1
(43) Pub. Date: Dec. 8, 2011

(54) STRUCTURE OF INCOMING CALL NOTIFYING WATCH

(76) Inventor: TUNG-LIN LU, Yonghe City (TW)

(21) Appl. No.: 12/792,740

(22) Filed: Jun. 3, 2010

(51) Int. Cl. H04M 1/00; H04B 10/06; H04B 7/00

(52) U.S. Cl. 455/41.3; 455/567; 398/118

(57) ABSTRACT

An incoming call notifying watch is worn on a wrist of a user and includes a case unit, a receiver unit, and an alarm unit. The case unit forms an interrior space receiving a timing device threin and has a face for displaying time. The case unit has opposite sides between which a band extends. The receiver unit is received in the case unit for receiving a wireless signal. The alarm unit is provided in the watch and receives a signal issued by the receiver unit and generates, in response thereto, a corresponding alarm signal. With such an arrangement, when a mobile phones receives an incoming call, the watch provides a corresponding alarm to notify the user of the receiving of the call.

### TECHNICAL FIELD OF THE INVENTION

The present invention generally relates to a structure of watch, and more particularly to a watch that notifies a wearer of an incoming call received in a mobile phone.

### DESCRIPTION OF THE PRIOR ART

With the significant development of wireless communication, mobile phone is a now an object that is carried by almost everyone. People communicate with each other through the mobile phone at any time and place. Such a technical product brings people with unbounded convenience and shortens the distance between people for people can do communication with friends and family members at any time and any place, domestically or abroad.

A mobile phone is provided with vibration and ringing means. When a call is received, the vibration or ringing means built in the mobile phone notifies the user of the incoming call.

However, such a notification issued by the existing mobile phone still surfer certain problems.

Although the incoming call notification is effective in signaling the phone user to pick up the call, yet it is often that the user places the phone in a bag and thus the user cannot get aware of an incoming call even if the phone rings or vibrates.

In view of this problem, the present invention aims to provide a solution to overcome such a problem.

### SUMMARY OF THE INVENTION

The present invention aims to provide an incoming call notifying watch that can be worn on a user's wrist to provide an alarm to notify the user of an incoming call transmitted to a mobile phone.

The primary objective of the present invention is to provide an incoming call notifying watch, which notifies a wearer or user of the watch of an incoming call received by a mobile phone when the mobile phone receives the call.

To achieve the above objective, the present invention provides an incoming call notifying watch, which is worn on a wrist of a user and comprises a case unit, a receiver unit, and an alarm unit. The case unit forms an interrior space receiving a timing device threin and has a face for displaying time. The case unit has opposite sides between which a band extends. The receiver unit is received in the case unit for receiving a wireless signal. The alarm unit is provided in the watch and receives an intermediate signal issued by the receiver unit and generates, in response thereto, a corresponding alarm signal.

The watch of the present invention comprises the receiver unit, which functions to receive a wireless signal, whereby when a mobile phone of a user of the watch receives an incoming call, the receiver unit immediately receives a signal from the mobile phone indicating the incoming call. The watch of the present invention also comprises the alarm unit, which receives a signal from the receiver unit and generates, in response thereto, a corresponding alarm signal, which can be any one of vibration, sound, displayed messages, and flashing or a combination of any of them. With such an arrangement, the user can get aware of an incoming call of the mobile phone through the alarm unit and thus the problem occurring heretofore that an incoming call transmitted to a mobile phone positioned in a carrying bag cannot be immediately recognized by a user.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of an incoming call notifying watch according to a preferred embodiment of the present invention worn on a user's wrist.

FIG. 2 is an exploded view of the watch of the present invention.

FIG. 3 is a perspective view illustrating an operation of the watch of the present invention.

FIG. 4 is a perspective view illustrating an operation of the watch of the present invention.

FIG. 5 is a perspective view illustrating an operation of the watch of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

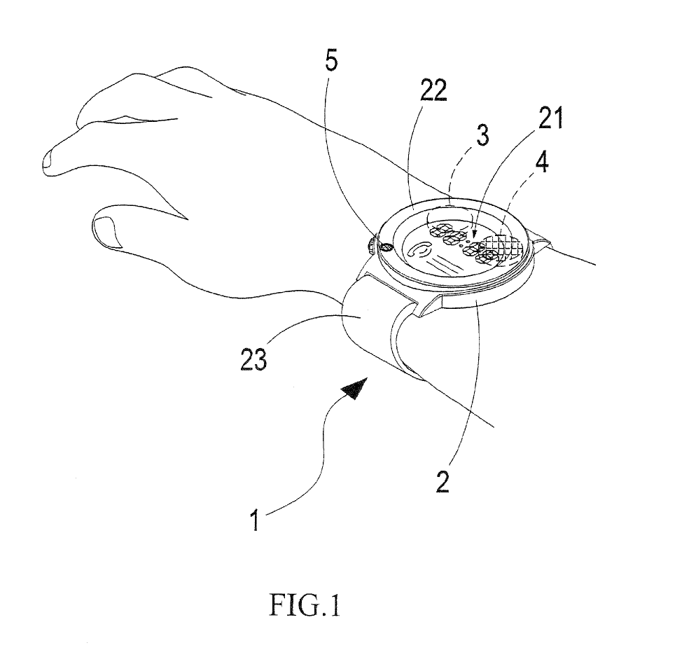

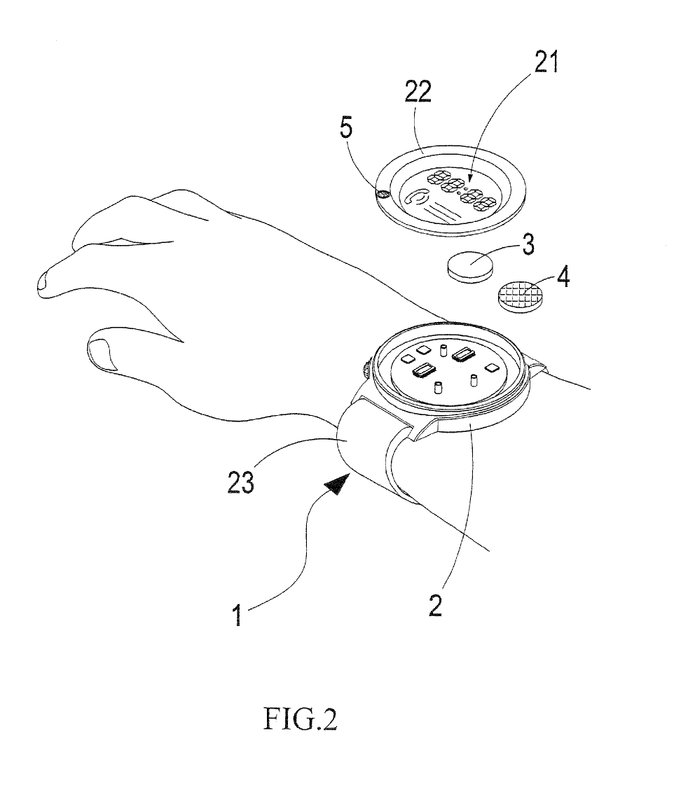

Referring to FIGS. 1 and 2, which show, respectively, a perspective view and an exploded view of a watch according to a preferred embodiment of present invention, as clearly shown in the drawings, the watch of the preferred embodiment of the present invention, which is generally designated at 1, is provided for being worn on a wrist of a user's hand.

The watch 1 comprises a case unit 2, which has an interior space receiving therein a timing device 21. The case unit 2 comprises a face 22 for displaying time of the timing device 21. A band 23 extends between opposite sides of the case unit 2.

A receiver unit 3 is arranged inside the case unit 2. The receiver unit 3 is structured to receive a wireless signal. For example, the receiver unit 3 comprises a Bluetooth wireless receiver module, a wireless receiver module of IEEE802.11a/b specification, or an infrared based wireless receiver module.

An alarm unit 4 is provided in the watch 1. The alarm unit 4 receives a signal issued from the receiver unit 3 and in response, generates an alarm signal corresponding to said signal. The alarm signal can be of any proper form, including vibration, sound, displayed messages, or flashing, but not limited thereto. The alarm signal can be displayed on the face 22, if proper.

Further, the watch 1 comprises a microphone/speaker unit 5. The watch 1 can be solar energy based so that the watch I can be re-charged by solar energy.

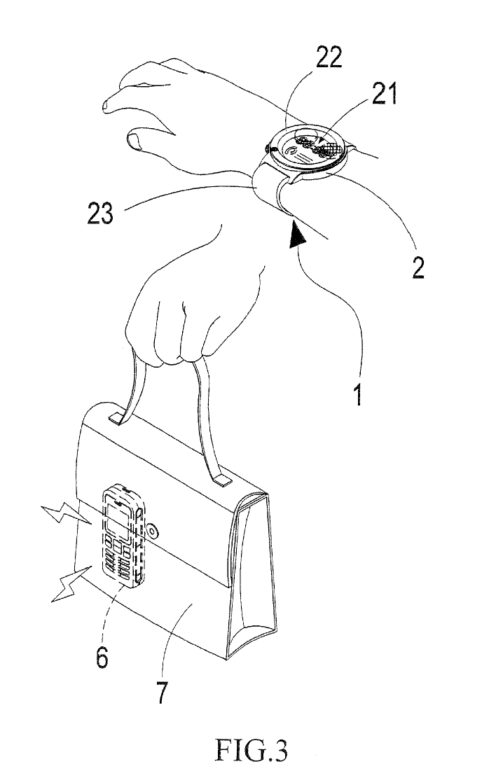

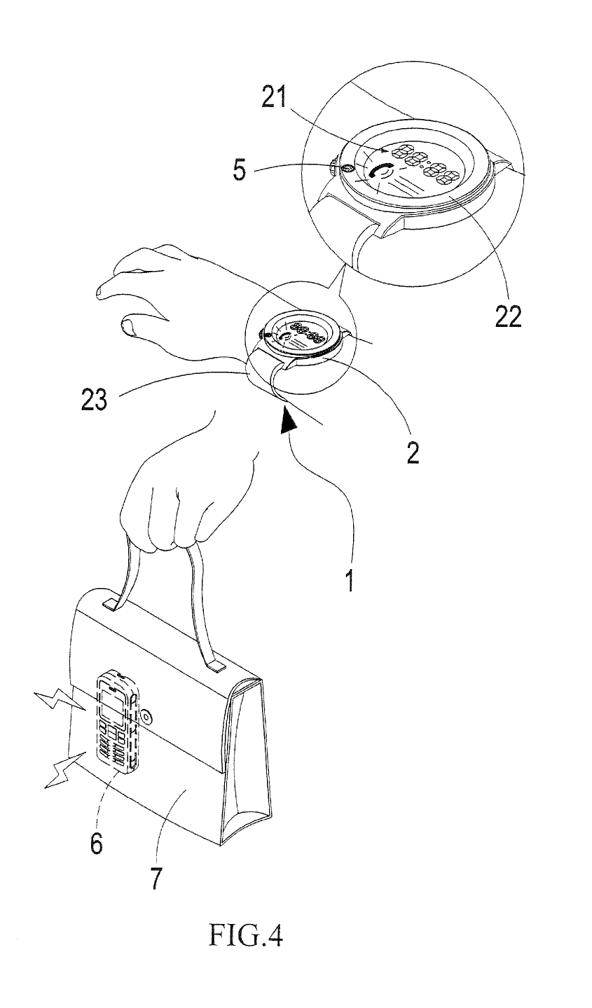

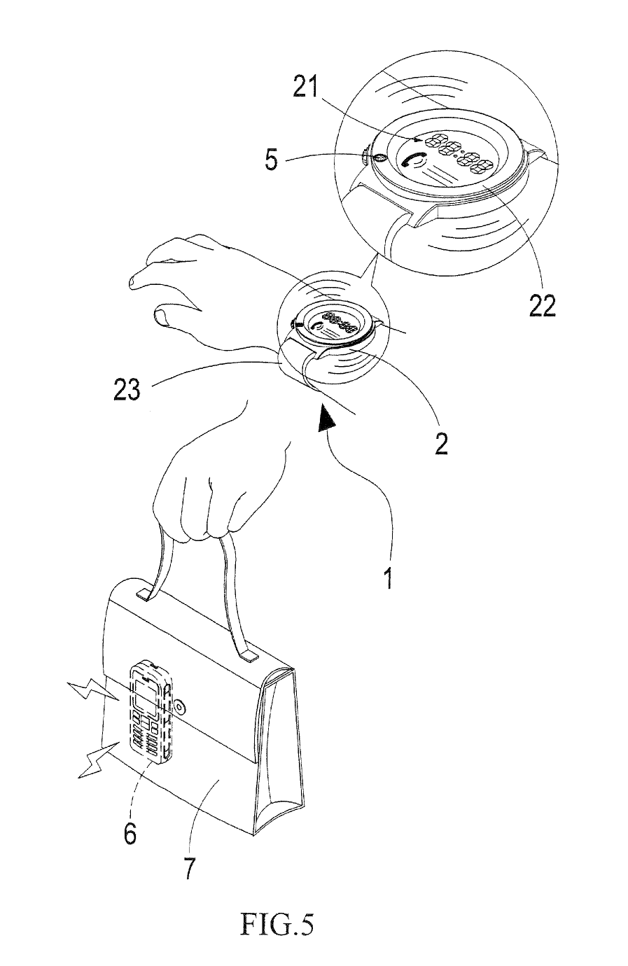

With the above arrangement, the operation of the present invention will be described as follows. Reference is now made to FIGS. 2-5, which are respectively an exploded view of the watch of the present invention and three prospective views illustrating various ways of operation of the watch of the present invention. The watch 1 of the present invention comprises the receiver unit 3, which functions to receive a wireless signal, whereby when a mobile phone 6 of a user of the watch receives an incoming call, the receiver unit 3 immediately receives a signal from the mobile phone 6 indicating the incoming call. The way of receiving the signal can be a Bluetooth wireless receiver module, a wireless receiver module of IEEE802.11a/b specification, or an infrared based wireless receiver module. The present invention also comprises the alarm unit 4, which receives a signal from the receiver unit 3 and generates, in response thereto, a corresponding alarm signal, which can be any one of vibration, sound, displayed messages, and flashing or a combination of any of them. With such an arrangement, even when the user is staying in a noisy environment or put the mobile phone 6 in a carrying bag 7, the watch 1 may receive a signal indicating the incoming call through the receiver device and the alarm unit 4 notifies the user of the incoming call of the mobile phone 6 through for example vibration or sounding, or even showing a message on the face 22, or giving off light or flashing.

Further, the watch 1 according to the present invention further comprises the microphone/speaker unit 5, whereby the user may use the microphone/speaker unit 5 to pick up the call so that communication can be done through the watch 1. This eliminates the problem that a user has to long wear a Bluetooth earphone in an ear and also shows an advantage that a call to the mobile phone 6 can be picked up quickly without causing hurry and flurry.

As compared to the conventional technology, the present invention provides the following advantages:

(1). The present invention is applied to a watch 1, and the watch, when used in a noisy environment, can help notifying a user of an incoming call received by a mobile phone 6.

(2). When the mobile phone 6 is put in a carrying bag 7, the watch 1 may help a user to get aware of an incoming call so that the user may not miss any called received in the mobile phone 6.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A watch adapted to be worn on a wrist of a user, comprising:
a case unit, which forms an interrior space receiving a timing device threin and has a face for displaying time, the case unit having opposite sides between which a band extends;
a receiver unit, which is received in the case unit and is adapted to receives a wireless signal; and
an alarm unit, which is provided in the watch and receives an intermediate signal issued by the receiver unit and generates, in response thereto, a corresponding alarm signal.

2. The watch according to claim 1, wherein the receiver unit comprises a Bluetooth wireless receiver module.

3. The watch according to claim 1, wherein the receiver unit comprises a wireless receiver module of IEEE802.11a/b specification.

4. The watch according to claim 1, wherein the receiver unit comprises an infrared wireless receiver module.

5. The watch according to claim 1, wherein the alarm signal comprises one of vibration, sound, displayed message, and flashing.

6. The watch according to claim 5, wherein the alarm signal is displayed on the face of the watch.

7. The watch according to claim 1 further comprising a microphone/speaker unit.

8. The watch according to claim 1, wherein the watch is rechargeable by solar energy.
